(19) United States
(12) Patent Application Publication
(10) Pub. No.: US 2014/0106304 A1
(43) Pub. Date: Apr. 17, 2014

(54) COMPRESSIVE DENTAL IMPLANT

(71) Applicant: Gravity Implants Ltd., Abu Ghosh (IL)

(72) Inventors: Amos Ben Yehouda, Zur Hadassa D.N. Haela (IL); Gabriel Ben Chetrit, Bet-Zayit (IL); Nir Ben Chtrit, Modi'in (IL)

(73) Assignee: Gravity Implants Ltd., Abu Ghosh (IL)

(21) Appl. No.: 14/043,382

(22) Filed: Oct. 1, 2013

Related U.S. Application Data
(63) Continuation-in-part of application No. 13/483,883, filed on May 30, 2012.

(51) Int. Cl. A61C 8/00; A61C 13/271; A61C 5/08

(52) U.S. Cl. CPC A61C 8/0022; A61C 8/0089; A61C 5/08; A61C 13/26
USPC 433/174

(57) ABSTRACT

The disclosure relates to dental implants. Specifically, the disclosure relates to a normal compressive, passive dental implant capable of reducing the negative impact of occlusal forces on the bone and the implant once a dental prosthesis is coupled onto the implant following osseointegration.

### CROSS REFERENCE TO RELATED APPLICATIONS

This application is a continuation-in-part of U.S. application Ser. No. 13/438,883, filed Apr. 4, 2012, the content of which is incorporated herein by reference in its entirety.

### BACKGROUND

The present disclosure is directed to dental implants. Specifically, the disclosure is directed to a dental implant configured to convert occlusal load acting on a dental prosthesis operably coupled to the implant to vertical compressive force acting apically along the implant.

Dental implants are used to secure dental prosthetics and other dental items (e.g., bridge) in the oral cavity. An important role of the implant is to achieve a firm, durable, intra-oral connection to the maxilla and mandible with a biologically compatible rigid structure. However, implant placement and ultimately performance is often compromised by the quality of bone (in other words, bone density in the affected area), and available ridge width.

Typical implants are aimed mainly at preservation and stabilization of the bone with osseointegration (referring to the integration of the implant into the surrounding bone tissue), used to substitute attachment by the periodontal ligament (PDL).

An implant that has undergone osseointegration can provide a good solution to the problem of implant retention and stability by itself. It can also allow bone distortion that is necessary for mechanical bone adaptation. However, the problem with this mechanism is that it ignores another important function of the periodontal ligament (PDL) apparatus, namely converting occlusal loads into normal stress vectors in the adjacent bone (referring to the uniform direction of the intense stress vectors that project perpendicularly (i.e. normal to the ridge line) toward the root), for its mechanical stimulation, thus increasing bone mass via a downregulation of the osteocytic bone remodeling

Thus although typical dental implants may preserve remote bone by its flexure; at the same time, these implants risk the supporting bone. Clinical follow up post-implant has illustrated bone loss along dental implants over time. This is supported by recent retrospective long term studies that show bone degeneration and perimplantitis around dental implants in substantial number of cases. Moreover, it seems that the older the implant the grater is the rate of bone resorption by osteoclasts.

Accordingly, there is a growing need to provide improved dental implants that will reduce the negative impact of shear stress on the bone and address the issues identified above.

### SUMMARY

Disclosed, in various embodiments, are compressive dental implants kits containing the dental implants and methods of use thereof.

In an embodiment, provided herein is a dental implant, including a flanged proximal head portion having flange diameter D_{f}, defining an opening therein configured to receive a turning tool; and an elongated cylindrical or frusto-conical body portion having a distal end and a longitudinal axis lᵢ, having a helicoidal square thread having: a variable or fixed pitch S; a variable turn length L; a fixed or variable core (minor) diameter D₁; and a variable outer (major) diameter D₂, wherein the pitch and turn are configured to convert occlusal forces acting on a dental prosthesis operably coupled to the implant to vertical compressive stress acting apically along the implant.

In an embodiment, provided herein is a kit including: a flanged proximal head portion defining an opening therein configured to receive a turning tool; an elongated cylindrical or frusto-conical body portion having a distal end and a longitudinal axis length lᵢ, having a helicoidal square thread having: a variable or fixed pitch S; a variable turn length L; a fixed core or variable diameter D₁ (minor); and a variable outer (major) diameter D₂, wherein the pitch and turn are configured to convert occlusal force acting on a dental prosthesis operably coupled to the implant to vertical compressive stress acting apically along the implant; optionally a frusto-conical drill bit configured to provide a bore having diameter D₃, wherein D₃=D₂ at any point along the longitudinal axis; optionally packaging; and optionally instructions.

In another embodiment, provided herein is a method of improving bone remodeling over time around a dental implant, including: drilling a bore in a predetermined site in the alveolar bone of a subject, wherein the bore is frusto-conical having dimension of the dental implant's body's outer (major) diameter (D₂); inserting into the bore a passive dental implant, including: a flanged proximal head portion having flange diameter D_{f}, defining an opening therein configured to receive a turning tool; and an elongated cylindrical or frusto-conical body portion having a distal end and a longitudinal axis lᵢ, including a helicoidal square thread having: a variable or fixed pitch S; a variable turn length L; a fixed or variable core (minor) diameter D₁; and a variable outer (major) diameter D₂, wherein the pitch and turn are configured to convert occlusal force acting on a dental prosthesis operably coupled to the implant to vertical compressive stress acting apically along the implant; and operably coupling a dental prosthesis to the flanged proximal head portion, wherein the compressive forces acting apically along the implant increase mechanical stimulation of the alveolar bone.

In yet another embodiment, provided herein is a dental implant, including: a flanged proximal head portion having flange area A_{f},; and an elongated body portion having a distal end and a longitudinal axis lᵢ, including a helicoidal square thread having: a fixed pitch S; a variable turn length L; a fixed core radial cross-sectional area A₁; and a variable outer radial cross sectional area A₂, wherein: the pitch and turn length are configured to convert occlusal loads acting on a dental prosthesis operably coupled to the implant post osseointegration to vertical compressive stress acting apically along the implant; wherein A₂ increases from the distal end of the elongated body portion towards the proximal flanged head portion; and wherein the largest area defined by the thread is less than A_{f}.

These and other features of the normal compressive passive dental implant will become apparent from the following detailed description when read in conjunction with the drawings, which are exemplary, not limiting.

### BRIEF DESCRIPTION OF THE FIGURES

A better understanding of the normal compressive dental implants described, with regard to the embodiments thereof, reference is made to the accompanying drawings, in which like numerals designate corresponding elements or sections throughout and in which:

FIGS. 1A and 1B are a three dimensional views of the normal compressive dental implant illustrating a cylindrical implant (FIG. 1A) and frusto-conical implant (FIG. 1B);

FIGS. 2A-2C, is a cross sectional front view (FIG. 2A) of an external hex collar embodiment of the normal compressive dental implant, further illustrating the helicoidal thread, a top view (FIG. 2B), and isometric view (FIG. 2C) of a proximal flanged hex head portion;

FIG. 3, is a cross sectional view of an embodiment of the normal compressive dental implant further illustrating forces applied on the dental implant, and by the dental implant as a case of internal hex implant;

FIG. 4, is a cross sectional view of an embodiment of the normal compressive dental implant in a bone; and

FIG. 5, is a bottom view of a frusto-conical embodiment of the elongated body portion of the passive and normal compressive implant.

### DESCRIPTION

Provided herein are embodiments of normal compressive passive dental implants. Specifically, provided are embodiments of monolithic or segmental dental implants configured to convert occlusal force acting on a dental prosthesis operably coupled to the implant to vertical compressive stress acting apically (in a direction towards an insertion or leading to the distal end of the component) along the implant, thus providing firm, durable, intra-oral connection to the jaw bones and assisting in osseointegration and minimizing shear stresses on the alveolar bone.

The disclosure relates to a device that allows a passive dental implant to minimize normal-compressive stresses along the dental implant and especially in the cervical (collar) area of the implant, thus stimulating remodeling of the bone in a similar way to remodeling of the bone around a natural tooth once a dental prosthesis is coupled to the dental implant, rather than around an implant.

Bone remodeling occurs in response to intermittent loads rather than constant levels of stress and strain. It has been shown that optimal capability of bone to withstand stress is when it is loaded by normal negative (compressive). Contrary to normal stresses and strains, shear stresses may be destructive to bone. In natural teeth, the PDL space has the capability to process occlusal forces into normal stress vectors that transmit normal strain in the contiguous bone around the root. The root serves simultaneously as a pivot point for distortion of the space of the basal bone. Thus the bone in the proximity of the root is exposed exclusively to normal strains while basal bone undergoes a degree of flexure and/or torsion. While normal strains stimulate mechanical bone adaptation in their environment, these forces are the kind of strains which the bone can most easily withstand.

Conventional active dental implants incorporate screws with standard thread profiles such as square, buttress threads, or circumferential grooves or even holes drilled through the device into which bone may grow to bind the screw. These implants require regeneration of bone to grow into and around the screw, which can be quite traumatic to the bone, and take months to fully anchor. In addition, conventional active implants can weaken the implant site as a result of occlusal processes because of the radial (normal to epical forces) spreading forces transferred from the tooth, via the screw, to the bone by their thread designs and grooved geometries.

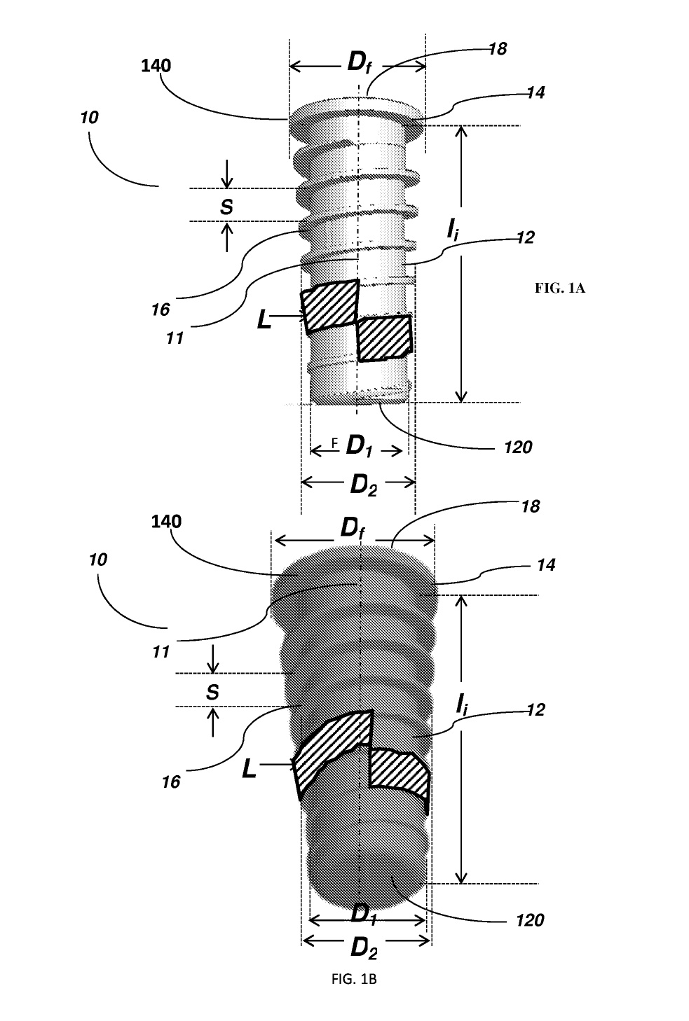

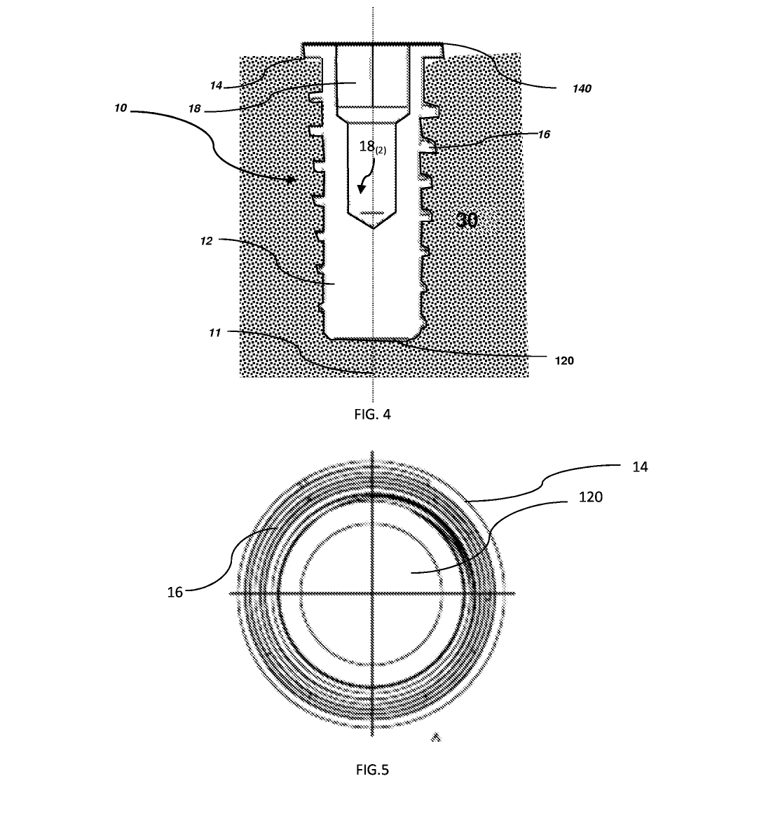

The dental implant is typically fabricated from pure titanium or a titanium alloy, although other bio-compatible or otherwise inert materials can be used (e.g., platinum, gold, ceramics sapphire, glass fiber enforced poly(carbonate)). The dental implant can typically include a body portion having a proximal (or coronal) end and a distal end and a collar (or a flange, see e.g., element 14 in FIGS. 1A and 1B). The elongated body portion is configured to extend into and osseointegrate with the alveolar bone (see e.g., FIG. 4). The top surface of the collar (or the flange), typically lies just over, just under or flush with the crest of the jawbone bone (typically below the gum line) and provides the support for any transmucosal component as well as transmitting the shear stresses applied when a dental prosthesis (e.g., fixed crowns, fixed bridges, fixed dentures precision removable dentures, removable overdentures, etc.). Typically, the coronal or crown portion of the collar (in other words, the flange) have machined- or polished surfaces, which can assist in preventing the accumulation of plaque and calculus and facilitate cleaning

In general, the elongated, cylindrical or frusto-conical body portion of the normal, passive compressive dental implant provided herein, which can be used in the kits described and enable the methods described can have, for example, the following dimensions:

| | Minor (core) | Major (outer) | | | Flange |
|---|---|---|---|---|---|
| Length | diameter | diameter | Pitch | Threads | Diameter |
| lᵢ mm | (D₁) mm | (D₂) mm | (S) mm | per cm | (D_{f}) mm |
| 5.0-16 | 3.0-5.0 | 3.3-5.5 | 1-1.4 | 7-10 | 4.0-6.0 |

The thread in an embodiment, is an thread, with thread thickness being fixed or variable apically along the thread and is between about 0.1 and about 0.3 mm.

Accordingly and in an embodiment, provided herein is a passive dental implant, including: a flanged proximal (coronal) head portion (or a collar portion) defining an opening therein configured to receive a turning tool (for example, an Ellen driver); and an elongated cylindrical or frusto-conical body portion configured to engage the flanged proximal head portion having a distal end, including a helicoidal square thread having: a fixed and/or variable pitch S; a variable turn length L; a fixed and/or variable core diameter D₁; and a variable outer diameter D₂, wherein the pitch and turn are configured to convert occlusal force acting on a dental prosthesis operably coupled to the implant to vertical compressive stress acting apically along the implant; and wherein the flanged proximal head portion is operably coupled to the elongated cylindrical or frusto-conical body portion. In an embodiment thread width (h_{T}) can also be fixed or variable and change apically such that proximal cervical thread width (at the collar vicinity) is larger than the thread width at the distal apical end and can be, for example between about 0.2 mm and about 0.5 mm width

The term “coupled”, including its various forms such as “operably coupling”, “coupling” or “couplable”, refers to and includes any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

Likewise, the term “engage” and various forms thereof, when used with reference to retention of the flanged proximal head portion (in other words, the collar portion) in the elongated cylindrical or frusto-conical body portion's engaging element, refer to the application of any forces that tend to hold the collar portion and the elongated cylindrical or frusto-conical body portion together against inadvertent or undesired separating forces (e.g., such as may be introduced during use of the tool to screw the body portion into the custom osseotomy site). It is to be understood, however, that engagement does not in all cases require an interlocking connection that is maintained against every conceivable type or magnitude of separating force. The term “engaging element” refers to one or a plurality of coupled components, at least one of which is configured for releasably engaging a collar portion (e.g., the flanged proximal head portion). Thus, this term encompasses both single part engaging elements and multi-part-assemblies.

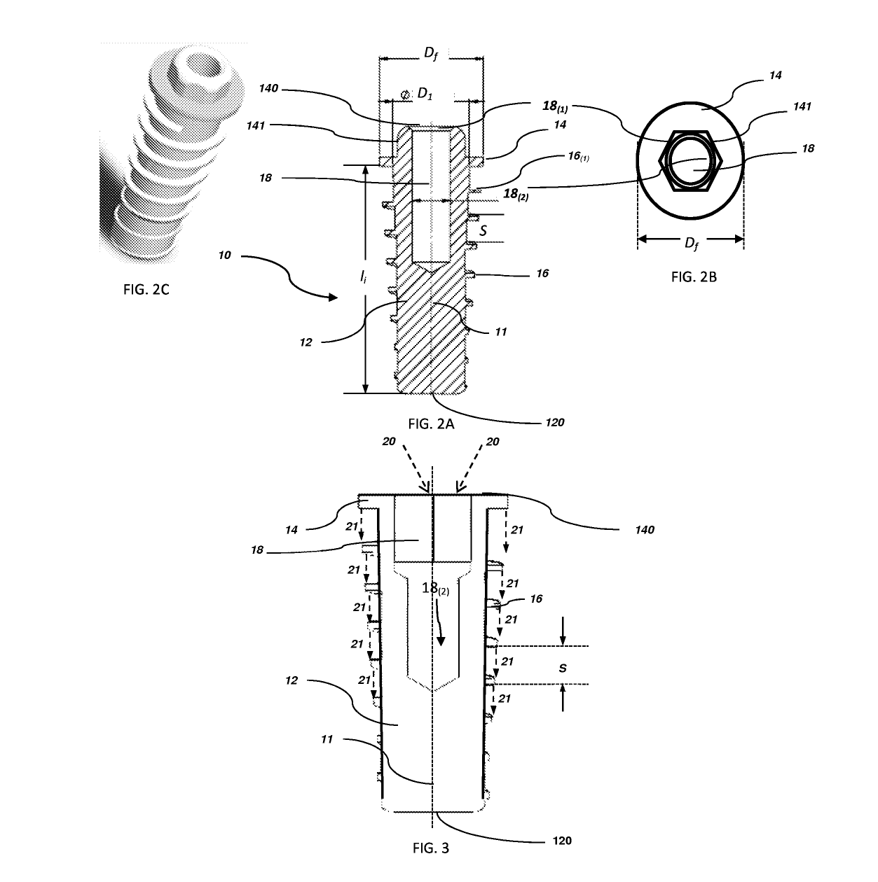

The pitch S of the thread disposed on the elongated cylindrical or frusto-conical body portion of the normal compressive dental implants described herein, can decrease in an embodiment from the distal end of the body portion (see e.g., element 120 in FIG. 1) toward the proximal flanged head portion (or collar portion). In another embodiment, the pitch can be fixed. The term “pitch,” as it is used in conjunction with the helicoidal thread, refers in an embodiment to the distance from a particular point on one thread, to the same particular point on an adjacent thread along the longitudinal axis (in other words, in a direction corresponding to an elongated direction), creating a single turn. The term “turn” should be understood as meaning that the thread is arranged in a helix (in other words, helicoidal) that extends over at least one complete revolution, thus going from 0 to 360° along the thread's outer diameter D₂ around the main longitudinal axis of the elongated cylindrical or frusto-conical body portion. In an embodiment, the thread extends over two or more turns. As shown in FIG. 2, the pitch of the thread disposed on the elongated cylindrical or frusto-conical body portion of the normal compressive dental implants described herein, can be variable and decrease from the distal end of the elongated cylindrical or frusto-conical body portion, for example by between about 0.1 mm to about 2.0 mm per turn, or between about 0.2 mm and about 1 mm per turn, specifically, between about 0.3 mm and about 0.8 mm per turn, or between about 0.4 mm per turn and about 0.6 mm per turn, more specifically, by about 0.5 mm per turn. The decrease can be monotonic (in other words, having a single [linear] rate of decrease with self-similarity along several turns creating a fractal dimension {d} or irregular, step change and other rates of changes that are not self-similar). In another embodiment, and as shown in FIG. 1A, 1B, the pitch of the thread disposed on the elongated cylindrical or frusto-conical body portion of the normal compressive dental implants described herein, can be fixed, measuring between about 0.1 mm to about 2.0 mm per turn, or between about 0.2 mm and about 1 mm per turn, specifically, between about 0.3 mm and about 0.8 mm per turn, or between about 0.4 mm per turn and about 0.6 mm per turn, more specifically, by about 0.5 mm per turn. In yet another embodiment, the pitch can be fixed for a certain portion of the axial length, and variable along the remainder.

In an embodiment, a drill bit is used to bore the alveolar bone at the desired site, creating an osseotomy site. The frusto-conical drill bit can have the dimensions of the elongated cylindrical and/or frusto-conical body portion of the passive implant below the proximal flanged head portion. Following the bore formation, the passive implant can be inserted into the osseotomy site, with the flanged proximal end resting above the osseotomy site, on the alveolar bone and below the gum line. By sealing the osseotomy site, the flange additionally prevents the gum tissue from entering the bore, thereby assisting in both guiding the remodeling into the spaces created by the passively inserted threads and the core of the body portion of the implant. The passive implant, or alternatively, the osseotomy site, can be contacted with a composition including cells and/or agents configured to accelerate bone remodeling, for example, an osteoblast, an osteoclast inhibitor, a stem cell or a mesenchymal stem cell (MSC), an antibiotic agent and the like, or a composition including a combination of at least one of the forgoing. The passive implant can then be capped using a temporary cap operably coupled to the flanged proximal head portion, for example by frictionally coupling to the opening defined in the flanged proximal head portion, such that any cavity in the passive implant is hermetically sealed. The gum line can then be sutured, sealing the passive implant above the flanged proximal head (coronal) portion. Following a remodeling period of about 10-15 weeks, which can be substantially shorter (e.g., 6-9 weeks) when the composition including cells and/or agents configured to accelerate bone remodeling are used, the sutures are opened and the dental prosthesis is coupled to the now osseointegrated implant.

Not wishing to be bound by theory, it is posited that following a period configured to allow for remodeling of the bone around the implant, the bone is remodeled such that threads closer to the cervical (collar) area penetrate deeper into the remodeled bone, than threads closer to the distal apical end, and in combination with the yet wider diameter flange, facilitating conversion of shear stress acting on the coupled dental prosthesis, to normal compressive forces acting apically in parallel with the implant's longitudinal axis, mechanically stimulating bone growth in much the same way a natural tooth root would.

The ratio between D₂ (see e.g., FIG. 1A, 1B), referring to the outer (major) diameter of the thread at any given point along the longitudinal axis of the elongated cylindrical or frusto-conical body portion, and D₁, referring to the core (minor) diameter of the square thread, or the outer diameter of the elongated cylindrical or frusto-conical body portion (at any given point) of the thread disposed on the elongated cylindrical or frusto-conical body portion of the normal compressive dental implants described herein, can be configured to increase from the distal end of the body portion toward the flanged proximal head portion along the longitudinal axis of the elongated cylindrical or frusto-conical body and longitudinal axis length lᵢ. As D₂ increases, so would turn length L, with rates of change that are the same or different as those described for the pitch S. Similarly, the considerations for the initial parameters and their rate of change can be the same or different to those described herein for the pitch S (in other words, dental prosthesis, age, gender, site, etc.). Accordingly and in an embodiment, the ratio between D2 and D1 can be between about 1.01 and about 2.00, or between 1.10 and about 1.80, specifically between 1.10 to about 1.70 or between about 1.20 to about 1.50.

In an embodiment, when the elongated body portion is frusto-conical, the increase in the surface area for any radial cross section (referring to a cross section that is perpendicular to the longitudinal axis) from the distal end of the elongated body portion to the proximal flanged head portion, stems not only due to the increase in the square thread's outer (major) diameter, but also due to the increase in the radial core diameter or corresponding surface area. A person skilled in the art would recognize, that other than cylindrical and frusto-conical elongated body portion members, other elongated members having different cross section shapes can be used, for example elongated members having a cross section that is oblong or have other equilateral side n, wherein n≧3.

As noted hereinabove, the flanged proximal (coronal) head portion, once implanted, is disposed over the bone and below the gum line and is instrumental in converting occlusal load acting on the implant during mastication once the dental prosthesis has been coupled to the implant to normal compressive stress acting on the upper area of the bone and apically along the implant. This area is the most vulnerable area of the bone that is attached to implants once the dental prosthesis has been operably coupled to the implant, because of shear stress As indicated, the flanged proximal head portion used in the normal compressive implants described herein can be removably coupled to the cylindrical body portion. The Term “removably coupled” as used herein, means that the proximal head portion can be inserted or attached in a functional configuration to the elongated cylindrical or frusto-conical body portion, and/or detached without causing damage to either the proximal head portion or the elongated cylindrical or frusto-conical body portion, and then re-attached without detriment to either components' intended function. In an embodiment, the proximal head portion can be coupled to the proximal end of the elongated cylindrical or frusto-conical body portion, which can be configured to selectively receive (in other words, optionally and in repeating manner) the proximal head portion. In an embodiment, the proximal head portion and the elongated cylindrical or frusto-conical body portion are fabricated as a monolithic unit, or in other words, a structure having or acting as a single, uniform structure.

In an embodiment, the flanged proximal head portion and the cylindrical or frusto-conical body portion used in the normal compressive implants described herein can be configured to convert occlusal load acting on a dental prosthesis operably coupled to the implant to vertical compressive force acting apically along the implant and applied on the bone

Moreover, the flange diameter D_{f} of the flanged proximal head portion (or collar portion) used in the normal compressive implants described herein can be selectively adjustable according to the ridge width at the site of the implant, as well as the type of dental prosthesis sought to be supported by the implant. The collar portion is used in an embodiment as support for dental prosthesis attached thereto and defines an opening configured to receive a tool for screwing the implant in when the collar portion and the elongated cylindrical or frusto-conical body portion are operably coupled to each other, or the opening also configured to engage, for example, an abutment or in another example, a screw-retained crown or denture. Accordingly, in an embodiment, the bore defined in the elongated cylindrical or frusto-conical body portion includes a thread configured to receive a complimentary thread disposed on a portion of a dental prosthesis.

In an embodiment, the normal compressive dental implants described herein are used in the kits provided herein. Accordingly, provided herein is a kit including: a flanged proximal head portion configured to receive a turning tool; an elongated cylindrical or frusto-conical body portion having a distal end and a longitudinal axis length lᵢ, including a helicoidal square thread having: a fixed and/or variable pitch S; a variable turn length L; a fixed and/or variable core diameter D₁; and a variable outer diameter D₂, wherein the pitch and turn are configured to convert occlusal load acting on a dental prosthesis operably coupled to the implant to vertical compressive force acting apically along the implant; optionally a drill bit configured to provide a bore having diameter D₃; optionally packaging; and optionally instructions.

The kits described herein can include a plurality of flanged head portions, having different flange diameters D_{f}, to accommodate a variety of biological widths in the subjects and various implant sites. The flanged head portion, or custom collars can be separate from the elongated cylindrical or frusto-conical body portion. The kits likewise can include a plurality of elongated body portions, each having different longitudinal axis length lᵢ variable pitch S, variable turn length L; fixed core diameter D₁; and variable outer diameter D₂ as well as a plurality of drill bits, each configured to provide different bore diameter D₃.

In an embodiment, the implants and kits described herein are used in the methods provided. Accordingly and in an embodiment, provided herein is a method of improving bone remodeling over time around a dental implant, including: drilling a bore in a predetermined site in the alveolar bone of a subject, wherein the bore is frusto-conical having dimension of the dental implant's body's outer diameter; inserting into the bore a dental implant, including: a flanged proximal head portion having flange diameter D_{f}, defining an opening therein configured to receive a turning tool; and an elongated cylindrical or frusto-conical body portion having a distal end and a longitudinal axis lᵢ, including a helicoidal square thread having: a variable or fixed pitch S; a variable turn length L; a fixed or variable core diameter D₁; and a variable outer diameter D₂, wherein the pitch and turn are configured to convert occlusal load acting on a dental prosthesis operably coupled to the implant to vertical compressive stress acting apically along the implant; and operably coupling a dental prosthesis to the flanged proximal head portion, wherein the compressive forces acting apically along the implant increase mechanical stimulation of the alveolar bone. In an embodiment, the step of operably coupling the dental prosthesis (e.g., fixed crowns, fixed bridges, fixed dentures precision removable dentures, removable overdentures, etc.), to the normal compressive implants provided herein, and that are configured to occlusal load acting on a dental prosthesis operably coupled to the implant to vertical compressive stress acting apically along the implant, is preceded by a step of suturing the gum above the proximal flanged end for a period configured to allow osseointegration of the cylindrical or frusto-conical elongated body portion before the coupling of the dental prosthesis sought to be supported by the implant.

A person skilled in the art would recognize that for the purposes of the present disclosure, directional or positional terms such as “top”, “bottom”, “upper,” “lower,” “side,” “front,” “frontal,” “forward,” “rear,” “rearward,” “back,” “trailing,” “above,” “below,” “left,” “right,” “horizontal,” “vertical,” “upward,” “downward,” “outer,” “inner,” “exterior,” “interior,” “intermediate,” “distal”, “proximal” etc., are merely used for convenience in describing the various embodiments of the retrievable detent-retained dental prostheses.

A more complete understanding of the components, processes, methods, kits and devices disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Turning now to FIGS. 1A and 1B, illustrating dental implant 10, including: a flanged proximal head portion 14 having flange diameter D_{f}, defining an opening 18, configured to receive a turning tool; and an elongated cylindrical (FIG. 1A) or frusto-conical (FIG. 1B) body portion 12 having a distal end 120 and a longitudinal axis lᵢ, including a helicoidal thread 16 having: a fixed and/or variable pitch S; a variable turn length L; a fixed and/or variable core diameter D1; and a variable outer diameter D₂, wherein the pitch and turn are configured to compress the bone toward the flanged proximal head portion. Also shown in FIG. 1, is longitudinal axis 11.

Turning now to FIGS. 2A-2C, illustrating a cross sectional front (FIG. 2A) view of an embodiment of the elongated cylindrical body portion external hex implant 12 having proximal end 140 and distal end 120, with bore 18 defining radial shelf 18₍₁₎ which can be configured to receive and engage selectively removable proximal head (or collar 141) portion 14. Also shown, is cross section 18₍₂₎ of the bore defined in elongated cylindrical body portion 12, having longitudinal axis 11, which may be configured to engage for example, screw-retained crown (not shown, see e.g., FIG. 5). As shown in FIGS. 2A-2C, thread 16 can have variable and/or fixed pitch S along longitudinal axis 11, as well as variable thread outer diameter D₂ (not shown see e.g., FIG. 1B), terminating in flanged proximal end 140 having flanged diameter D_{f}. As shown Flange diameter D_{f}, is larger than the major diameter (D₂, not shown) of adjacent thread 16₍₁₎. Top view of the flanged proximal head portion is illustrated in FIG. 2B, showing flange 14, having flange diameter Df that is larger than the most adjacent thread's outer (major) diameter (D₂, not shown) defining opening 18 therein, with a radial shelf 18₍₁₎ configured to engage a dental prosthesis portion (not shown) and bore 18₍₂₎, which can be threaded and configured to receive a different portion of dental prosthesis (22, not shown). Also shown is collar 141, having a hexagonal outer dimension (see e.g., FIG. 2C) that can be used for turning the implant 10

Turning now to FIGS. 3 and 5, illustrating a cross sectional front view (FIG. 3) of an embodiment of the normal compressive internal hex implant dental implant 10 further illustrating shear forces 20 applied on the dental implant, by a coupled dental prosthesis (not shown) and by the dental implant 21 after converting the shear stresses to normal compressive forces, thus minimizing and distributing the forces normal-compressive stresses along the dental implant apically and especially in the cervical area of the implant where these forces tend to create the most damaging micro-movement and beneficially mechanically stimulating bone remodeling. The redistribution and conversion of angular occlusal load 20, to normal compressive stress 21 acting in parallel with implant 10 elongated body portion 12 longitudinal axis 11, can be enable at least in part because the area under each thread 16 is larger than the area under the apically adjacent thread toward distal end 120 as illustrated in bottom view shown in FIG. 5.

Turning now to FIG. 4, illustrating a cross sectional view of an embodiment of the monolithic normal compressive dental implant 10 in alveolar bone 30 with flanged proximal head portion 14 resting just above ridge line 32 with bore 18, disposed coaxially with longitudinal axis 11. As shown, elongated cylindrical body portion 12 is embedded in bone 30, with thread 16 also embedded within the bone, assisting in distribution and minimizing shear stress forces applied to implant 10 once a dental prosthesis is coupled to the dental implant.

Accordingly, provided herein is a dental implant, including: a flanged proximal head portion (or a collar portion) defining an opening therein configured to receive a turning tool; and an elongated cylindrical or frusto-conical body portion configured to engage the flanged proximal head portion having a distal end, including a helicoidal square thread having: a fixed and/or variable pitch S; a variable turn length L; a fixed and/or variable core diameter D1; and a variable outer diameter D₂, wherein the pitch and turn are configured to convert occlusal force acting on a dental prosthesis operably coupled to the implant to vertical compressive stress acting apically in parallel with the implant's longitudinal axis and wherein the flanged proximal head portion is operably coupled to the elongated cylindrical or frusto-conical body portion, wherein (i) the pitch S decreases from the distal end of the body portion toward the proximal flanged head portion, (ii) the ratio between D₂/D₁ increases from the distal end of the body portion toward the flanged proximal head portion, (iii) the turn length L decreases from the distal end of the body portion toward the flanged proximal head portion, (iv) the dental prosthesis is a fixed crown, a fixed bridge, a fixed denture, a precision removable denture, or a removable overdenture, (v) the flanged proximal head portion is operably coupled to the elongated cylindrical or frusto-conical body portion, (vi) he flanged proximal head portion and the cylindrical body portion are monolithic,

In another embodiment, provided herein is a kit including: a flanged proximal head portion configured to receive a turning tool; an elongated cylindrical or frusto-conical body portion having a distal end and a longitudinal axis length lᵢ, including a helicoidal square thread having: a fixed and/or variable pitch 5; a variable turn length L; a fixed and/or variable core diameter D1; and a variable outer diameter D₂, wherein the pitch and turn are configured to convert occlusal load acting on a dental prosthesis operably coupled to the implant to vertical compressive stress acting apically in parallel with the implant's longitudinal axis; optionally a drill bit configured to provide a bore having diameter D₃; optionally packaging; and optionally instructions, further (viii) including a plurality of flanged head portions, having different flange diameters D_{f}, (ix) a plurality of elongated body portions, each having different longitudinal axis length lᵢ, variable and/or fixed pitch S, variable turn length L; fixed and/or variable core diameter D₁; and variable outer diameter D₂, (x) a plurality of drill bits, each configured to provide different bore diameter D₃, each configured to create a cylindrical and/or frusto-conical bore,

In yet another embodiment, provided herein is a method of improving bone remodeling over time around a dental implant, including: drilling a bore in a predetermined site in the alveolar bone of a subject, wherein the bore is cylindrical or frusto-conical having dimension of the dental implant's body's outer diameter; inserting into the bore a dental implant, including: a flanged proximal head portion having flange diameter D_{f}, configured to receive a turning tool; and an elongated cylindrical or frusto-conical body portion having a distal end and a longitudinal axis lᵢ, including a helicoidal square thread having: a variable or fixed pitch S; a variable turn length L; a fixed or variable core diameter D₁; and a variable outer diameter D₂, wherein the pitch and turn are configured to convert occlusal load acting on a dental prosthesis operably coupled to the implant to vertical compressive stress acting apically in parallel with the implant's longitudinal axis; and operably coupling a dental prosthesis to the flanged proximal head portion, wherein the compressive forces acting apically along the implant increase mechanical stimulation of the alveolar bone, wherein (xii) the step of operably coupling a dental prosthesis to the flanged proximal head portion is preceded by coupling a cap onto the opening configured to receive a turning tool; and, suturing the gum over the cap for a period configured to allow osseointegration of the cylindrical or frusto-conical elongated body portion before the coupling of the dental prosthesis sought to be supported by the implant, (xiii) the ratio between D₂/D₁ increases from the distal end of the body portion toward the flanged proximal head portion, (xiv) the turn length L decreases from the distal end of the body portion toward the flanged proximal head portion, (xv) the flanged proximal head portion is operably coupled to the elongated cylindrical or frusto-conical body portion, (and (xvii) the dental prosthesis is a fixed crown, a fixed bridge, a fixed denture, a precision removable denture, or a removable overdenture.

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as including (i.e., open language).

The term “about” means that amounts, sizes, scalars, vectors, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, scalar, vector, parameter or other quantity or characteristic is “about” or “approximate” whether or not expressly stated to be such and reflects a tolerance of, for example, +/−25% from the stated value, +/−20% from the stated value, +/−15% from the stated value, +/−10% from the stated value, or +/−5% from the stated value.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

We claim:

1. A dental implant, comprising:
(a) flanged proximal head portion having flange diameter D_{f}, defining an opening configured to receive a turning tool; and
(b) an elongated cylindrical or frusto-conical body portion having a distal end and a longitudinal axis lᵢ, comprising a helicoidal square thread having:
a fixed and/or variable pitch S;
a variable turn length L;
a fixed and/or variable core diameter D1; and
a variable outer diameter D₂,
wherein the pitch and turn are configured to convert occlusal load acting on a dental prosthesis operably coupled to the implant to vertical compressive stress acting apically in parallel with the implant's longitudinal axis.

2. The implant of claim 1, wherein the pitch S decreases from the distal end of the body portion toward the proximal flanged head portion.

3. The dental implant according to claim 1, wherein the ratio between D₂/D₁ increases from the distal end of the body portion toward the flanged proximal head portion.

4. The dental implant of claim 1, wherein the turn length L decreases from the distal end of the body portion toward the flanged proximal head portion.

5. The dental implant of claim 1, wherein the area under each thread is larger than the area under the apically adjacent thread and the maximal area is under the flange independent of the area of the elongated cylindrical and/or frusto-conical body portion.

6. The dental implant of claim 1, wherein the thread is a square thread having thread width of between about 0.2 mm and about 0.3 mm, and the flange has a substantially rectangular cross section with its short side having a width of between about 0.2 mm and about 0.3 mm.

7. The dental implant of claim 1, wherein the flange is disposed perpendicular to the elongated cylindrical or frusto-conical body portion's longitudinal axis.

8. The dental implant according to claim 1, wherein the dental prosthesis is a fixed crown, a fixed bridge, a fixed denture, a precision removable denture, or a removable overdenture.

9. The dental implant according to claim 1, wherein the flanged proximal head portion is operably coupled to the elongated cylindrical or frusto-conical body portion.

10. The dental implant according to claim 1, wherein the flanged proximal head portion and the cylindrical body portion are monolithic.

11. A kit comprising:
(a) a flanged proximal head portion defining an opening configured to receive a turning tool;
(b) an elongated cylindrical or frusto-conical body portion having a distal end and a longitudinal axis length lᵢ, comprising a helicoidal square thread having:
a fixed and/or variable pitch S;
a variable turn length L;
a fixed and/or variable core diameter D₁; and
a variable outer diameter D₂, wherein the pitch and turn are configured to convert occlusal load acting on a dental prosthesis operably coupled to the implant to vertical compressive stress acting apically in parallel with the implant's longitudinal axis;
optionally a drill bit configured to provide a bore having diameter D₃;
optionally packaging; and
optionally packaging and instructions.

12. The kit of claim 11, comprising a plurality of flanged head portions, having different flange diameters D_{f}.

13. The kit of claim 11, comprising a plurality of elongated body portions, each having different longitudinal axis length lᵢ, variable and/or fixed pitch S, variable turn length L; fixed and/or variable core diameter D₁; and variable outer diameter D₂.

14. The kit of claim 11, comprising a plurality of drill bits, each configured to provide different bore diameter D₃, each configured to create a frusto-conical bore.

15. A method of improving bone remodeling over time around a dental implant, comprising:
(a) drilling a bore in a predetermined site in an alveolar bone of a subject, wherein the bore is cylindrical or frusto-conical having dimension of the dental implant's body's outer diameter;
(b) inserting the dental implant into the alveolar bone, the dental implant, comprising: a flanged proximal head portion having flange diameter D_{f}, defining an opening configured to receive a turning tool; and an elongated cylindrical or frusto-conical body portion having a distal end and a longitudinal axis lᵢ, comprising a helicoidal square thread having:
a variable and/or fixed pitch S;
a variable turn length L;
a fixed or variable core diameter D₁; and
a variable outer diameter D₂, wherein the pitch and turn are configured to convert occlusal load acting on a dental prosthesis operably coupled to the implant, to vertical compressive stress acting apically in parallel with the implant's longitudinal axis; and
(c) operably coupling a dental prosthesis to the flanged proximal head portion, wherein the compressive forces acting apically along the implant increase mechanical stimulation of the alveolar bone.

16. The method of claim 15, wherein the step of operably coupling a dental prosthesis to the flanged proximal head portion is preceded by:
(a) coupling a cap onto the opening configured to receive a turning tool; and
(b) suturing the gum over the cap for a period configured to allow osseointegration of the cylindrical or frusto-conical elongated body portion before the coupling of the dental prosthesis sought to be supported by the implant.

17. The method of claim 15, wherein the ratio between D₂/D₁ increases from the distal end of the body portion toward the flanged proximal head portion and is at a maximum under the flange independent of the area of the elongated cylindrical and/or frusto-conical body portion.

18. The method of claim 16, wherein, following osseointegration, the radial penetration of threads into the bone increases the closer the thread is to the flange.

19. The method of claim 17, wherein the turn length L decreases from the distal end of the body portion toward the flanged proximal head portion.

20. The method of claim 17, wherein the flanged proximal head portion is operably coupled to the elongated cylindrical or frusto-conical body portion.

21. The method of claim 17, wherein the dental prosthesis is a fixed crown, a fixed bridge, a fixed denture, a precision removable denture, or a removable overdenture.

22. A dental implant, comprising:
(a) a flanged proximal head portion having flange area A_{f},; and
(b) an elongated body portion having a distal end and a longitudinal axis lᵢ, comprising a helicoidal square thread having: a fixed pitch S; a variable turn length L; a fixed core radial cross-sectional area A₁; and a variable outer radial cross sectional area A₂, wherein:
(i) the pitch and turn length are configured to convert occlusal loads acting on a dental prosthesis operably coupled to the implant post osseointegration to vertical compressive stress acting apically along the implant;
(ii) wherein A₂ increases from the distal end of the elongated body portion towards the proximal flanged head portion independent of the area of the elongated body portion; and
(iii) wherein the largest area defined by the thread is less than A_{f}.
